(19) United States
(12) Patent Application Publication
(10) Pub. No.: US 2008/0193729 A1
(43) Pub. Date: Aug. 14, 2008

(54) Film Membrane with Excellent Weather-Resistant Properties, High Transmission of Solar Thermal Radiation, Effective Retention of Thermal Radiation Emitted by the Earth and High Degree of Mechanical Strength and Method for Producing Said Film Membrane

(75) Inventors: Thomas Arndt, Luetzelbach (DE); Guenther Dickhaut-Bayer, Riedstadt (DE); Lim Hendra Irawan, Bandung (ID); Alexander Laschitsch, Frankfurt (DE); Achim Neuhaeuser, Mainz (DE); Uwe Numrich, Gross-Zimmen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: ROEHM GMBH, Darmstadt (DE)

(21) Appl. No.: 11/816,130

(22) PCT Filed: Feb. 1, 2006
(86) PCT No.: PCT/EP2006/000852

§ 371 Date: Oct. 9, 2007

(30) Foreign Application Priority Data
Feb. 8, 2005 (DE) 102005005836.1
Apr. 26, 2005 (DE) 102005019669.1

(51) Int. Cl. B32B 33/00; B32B 27/32; B05D 1/36

(52) U.S. Cl. 428/216; 428/483; 427/209

(57) ABSTRACT

The invention relates to a film membrane which has excellent weathering resistance and high permeability to thermal insolation, and is an effective barrier to thermal radiation emitted from the ground and has high mechanical strength, and also to a process for the production of the film membrane. The properties are achieved via a composite of a base film of thermoplastic and an outer layer of poly(meth)acrylate. The adhesion is achieved via copolymers with polar character. One or more layers of the plastics moulding may also have been equipped with flame retardants.

### FIELD OF THE INVENTION

The invention relates to a product which not only has high permeability to visible light but also provides a high barrier to thermal radiation and, furthermore, has excellent weathering resistance, and to a process for coating with an outer layer of polymethyl (meth)acrylate (PMMA). The base is composed of a textile of thermo-plastics, such as HD polyethylene (HDPE), polypropylene (PP) or polyesters. Between the coating of PMMA and the textile, one or more additional plastics mouldings may have been arranged, if appropriate, these improving the adhesion of the composite.

### PRIOR ART

The present invention is oriented towards a process for producing composite materials. In particular, the invention relates to a process for the surface finishing of materials by means of polymethyl (meth)acrylate layers. The polymer layers used for surface finishing here, based on polymethyl (meth)acrylates, are prepared from certain polymethyl (meth)acrylate copolymers and are applied in a certain manner to the substrates.

Surface-finished articles are known manufacturing products which are desirable for many different uses, because they have the advantageous combination of physical properties not possessed by the individual components of the material.

Polymethyl (meth)acrylates are known to give surface-finished materials a high level of desired properties, in particular high transparency, scratch resistance and weathering resistance.

There has therefore been no lack of attempts to prepare, for example, PMMA-coated materials. However, one problem with these coatings is the fact that there is often no, or only very little, adhesion between the layers of different types. This leads to premature separation of the protective layer, or at least to limited processability of the composite materials.

An ideal protective layer has good adhesion to the substrate, and at the same time is hard and flexible, resistant to the effects of weathering, solvents, abrasion and heat. It is difficult to optimize all of these properties, because improvement in one property is mostly achieved at the expense of others. Specifically during the machining and shaping of previously surface-finished substrates, high elasticity and adhesion is desirable in order to prevent break-away of the protective layer at points of small-radius curvature. At the same time, the protective layer should be sufficiently hard to resist mechanical effects.

Adhesives can be utilized to ensure adequate adhesion between the surface finish and the materials, which mostly have a chemically different structure. In this connection it has moreover proven advantageous to construct covalent bonds between the substrate and the protective layer (termed: capstock) (Schultz et al., J. Appl. Polym. Science 1990, 40, 113-126; Avramova et al. 1989, 179, 1-4). By way of example, this is achieved via incorporation of specific monomers (reactive monomers) into the polymer matrix of the protective layer, these being capable of reacting with the radicals of the reactive monomers on the surface of the substrate or the adhesive adhering thereto.

EP 911 148 proposes adhesives which comprise, inter alia, “reactive monomers” and are suitable for attaching LCP films to polyethylene substrates. The multiple films are heated above the melting point of the highest-melting individual component, in order to achieve intimate fusion between the individual films.

EP 271 068 reports blends composed of polyvinyl fluorides and of PMMA-GMA copolymers, which are laminated at elevated temperatures to modified styrene polymer sheets.

DE 10 010 533 proposes a multiple layer film composed of two layers, the first layer being composed of acrylic resin and the second layer in each case a copolymer of either an acrylic resin and of an olefin-based copolymer, obtained via copolymerization of an olefin and of at least one monomer selected from, by way of example, unsaturated carboxylic acids, carboxylic anhydrides or glycidyl-containing monomers. This film is intended to have excellent melt adhesion to polyolefin-based resin substrates. This process therefore laminates two polymer layers one to the other and then, by means of an adhesive-bonding and forming process, for example, applies their side comprising the “reactive monomers” to the polyolefin resin intended for lamination.

DE 43 370 62 laminates metal sheets with triple layers composed of thermoplastic resins in such a way that the temperature established during the extrusion-coating procedure is above the glass transition temperature of the inner resin layer by at least 300° C.

The Japanese application H9-193189 describes, as does DE 10 0105 33, a multiple layer composite composed of a first layer which is composed of a thermoplastic PMMA, a second layer composed of a reactively modified polyolefin and a third layer which is composed of a coloured olefin polymer.

To obtain the desired abovementioned advantageous properties of the materials, such as high and long lasting adhesion, etc., the prior art merely proposes specific individual solutions which cannot be generalized or which have apparent disadvantages relating to apparatus cost or logistics cost, for example in particular the processing of multilayer materials as protective layer.

On the basis of this known prior art, therefore, there still remains a need for new surface finishing techniques which provide advantages for technical applications or in the production process.

It was therefore an object of the present invention to provide a further process for the surface finishing of materials, and to provide the composite materials produced by means of this process. The process should in particular permit the person skilled in the art to apply a polymethyl (meth)acrylate-based protective layer (capstock) in a very simple and efficient manner to a very large number of substrate materials, with maximum development of the abovementioned advantageous and desired properties. A factor to which very particular attention should be paid is that the variability of substrate materials should not be gained at the expense of efficiency and ease of operation of the process used according to the invention on an industrial scale.

A further object was to develop, for an existing textile composed of thermoplastics, such as polyethylene or polypropylene or polyester, in particular HDPE, a coating which is
mechanically stable
weather-resistant
UV-resistant and
transparent.

Production costs should moreover be minimized via a continuous coating process.

Furthermore, the various elements of the coating are not to result in any excessive rise in the weight per unit surface area of the film as a result of the coating of the textile.

Another object of the present invention is to apply a protective film of PMMA copolymer as capstock to a SOLARSHIELD® (producer: PT Carillon) greenhouse film membrane known per se.

Another object to be achieved by the present invention consists in providing flame retardancy (B1) to the composite of greenhouse film membrane of HDPE, of PP or of polyesters (PET) and PMMA outer film. The fire protection provided in the inventive film may, by way of example, be
a) in the capstock,
b) in the greenhouse film membrane or
c) in both parts.

The object is achieved via a process with the features of the present Claim 11 and via a plastics moulding according to Claim 1. Preferred embodiments of the inventive process can be found in the subclaims dependent on Claim 11. Claim 1 protects the composite materials thus produced, and Claim 17 claims their inventive uses.

The inventive plastics moulding is composed of more than one layer:
Layer 1 is composed of an olefinic polymer or of an ethyl-vinyl acetate polymer or of a copolymer of an olefin and ethyl-vinyl acetate,
layer 2 is composed of a textile of oriented fibres of a thermoplastic polymer, for example of polyethylene, preferably of HDPE, of poly-propylene or of polyester (PET), or of a poly-amide,
the optional layer 3 is composed of an olefinic polymer or of an ethyl-vinyl acetate polymer or of a copolymer of an olefin and ethyl-vinyl acetate,
layer 4 is composed of an adhesion promoter, and if layer 1 is composed of an olefinic polymer the adhesion promoter is also composed of an olefinic polymer, and if layer 2 is composed of another thermoplastic polymer the adhesion promoter is composed of a polymer capable of producing adequate adhesion between the adjacent layers.
Layer 5 is based on a polymethyl methacrylate copolymer.

The layers generally have the following thicknesses:
layer 1 from 20 μm to 100 μm,
layer 2 is composed of a textile of oriented fibres with from 8×8 mm to 12>12 fibres per inch (2.54 mm) 1400 to 800 dernier,
layer 3 from 0 μm to 100 μm,
layer 4 from 2 μm to 100 μm,
layer 5 from 5 μm to 150 μm.

Constitution of the layers:

Layer 1 is composed of a low-density poly-ethylene (LDPE).

The LDPE used in layer 1 is very particularly suitable for extrusion coating and has the following properties by way of example:

| Variable | Method | Value |
|---|---|---|
| Melt flow index | ASTM D1238 | 10.0 |
| g/10 min | | |
| Density | ASTM D1505 | 0.919 |
| g/cm³ | | |
| Vicat point | ASTM D1525 | 83 |
| ° C. | | |
| Melting point | ASTM D3417 | 105 |
| ° C. | | |
| Yield stress | ASTM D638 | 90 |
| MPa | | |
| Tensile stress at break | ASTM D638 | 90 |
| MPa | | |
| Tensile strain at break % | ASTM D638 | 500 |
| Water vapour permeability | ASTM F1249-90 | 17 |
| g/m²/24 h | | |

The product is marketed as 963 LDPE from HANWHA Chemical Corp.

Layer 2 is composed, by way of example, of an oriented high-density polyethylene textile (HDPE). The HDPE textile in layer 2 is composed, by way of example, of a polyethylene with the following properties:

| Variable | Method | Value |
|---|---|---|
| Density | JIS K7112:99 | 951 |
| kg/m³ | | |
| Melt flow index | JIS K7210:99 | 0.87 |
| g/10 min [2.16 kg] | | |
| Yield stress | JIS K7161:94 | 27 |
| MPa | | |
| Nominal tensile strain | JIS K7161:94 | 300< |
| at break % | | |
| Modulus of elasticity | JIS K7161:94 | 1100 |
| from tensile test | | |
| MPa | | |
| Flexural strength | JIS K7171:94 | 25 |
| MPa | | |
| Modulus in flexural test | JIS K7171:94 | 1300 |
| MPa | | |
| Charpy impact resistance | JIS K7111:96 | 11 |
| kJ/m² | | |
| Durometer hardness - | JIS K7215:86 | 66 |
| Deflection temperature | JIS K7191-1,2:96 | 72 |
| under load | | |
| ° C. | | |
| Stress cracking | ASTM D 1693:00 | 25 |
| resistance h | | |

Layer 3 is composed of
a) a polar copolymer of EVA and LDPE or
b) of EVA or
c) of LDPE or
d) of copolymers of LDPE and polar comonomers or
e) of copolymers of PE and polar comonomers.

If layer 3 is composed of an LDPE, the LDPE used in layer 1 may be used. (Case c)) In case b), layer 3 is composed, by way of example, of an ethylene-vinyl acetate copolymer having 18% vinyl acetate content; by way of example, this type of copolymer is marketed with the trade name Hanwha Polyethylene 1157 by HANWHA Chemical Corp. and has the following properties:

| Variable | Method | Value |
|---|---|---|
| Vinyl acetate content | HCC method | 18.0 |
| % by weight | | |
| Melt flow index | ASTM D1238 | 16 |
| g/10 min | | |
| Density | ASTM D1505 | 939 |
| kg/m³ | | |
| Ultimate tensile strength | ASTM D638 | 138 |
| kg/cm² | | |
| Elongation % | ASTM D638 | 860 |
| Vicat | ASTM D1525 | 61 |
| ° C. | | |
| Melting point | DSC method | 85 |
| ° C. | | |

Layer 4 is composed of copolymers of PE and further, polar monomers.

In addition to the measures described, it can be advantageous to apply one or more adhesives or adhesion promoters between the polymethyl (meth)acrylate-based protective layer to be applied and the material, i.e. to use an adhesive or adhesion promoter to treat the material on the protective-layer side prior to application of the protective layer. This is necessary particularly when the material for finishing is inadequately capable or completely incapable of forming chemical bonds to the polymethyl (meth)acrylate layer to be used for surface-finishing. According to the invention, the material for finishing in these cases is the original material together with adhesive or adhesion promoter. The adhesive or adhesion promoter here should be of the type which enters into reactive interactions with the protective layer in such a way as to maximize covalent bonding between protective layer and adhesive. These types of adhesive or adhesion promoter are known in principle to the person skilled in the art. Preferred adhesive materials are suggested in Römpp Chemie Lexikon [Römpp's Chemical Encyclopaedia], Georg Thieme Verlag Stuttgart, 9th Edition, 1990, Volume 3, pp. 2252 et seq. For the purposes of the invention, particular preference is given to adhesives or adhesion promoters selected from the group consisting of glycidyl methacrylate-modified polyolefins, e.g. Elvalloy® AS, Dupont, and ethylene-vinyl acetate copolymers (e.g. Mormelt® 902, Rohm and Haas Co.).

The usual industrial methods can be used to apply the adhesive or adhesion promoter to the textile. The extrusion coating process is preferred.

An adhesive or adhesion promoter is either a solvent-based adhesive or a substance whose chemical functionality makes it capable of increasing the adhesion between the layers. By way of example, glycidyl meth-acrylate-modified polyolefins are used.

Layer 5 is based on a PMMA copolymer of the following constitution: of polymerized monomer mixtures a. and b. and, if appropriate, c,
where a. comprises:
   A) from 20 to 100% by weight of methyl (meth)-acrylate,
   B) from 0 to 80% by weight of a (meth)acrylate of the formula I, other than methyl (meth)-acrylate,

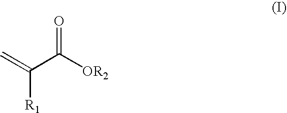

where
   R₁ is hydrogen or methyl and
   R₂ is a linear or branched alkyl radical or cycloalkyl radical having from 1 to 18 carbon atoms or is phenyl or naphthyl,
C) from 0 to 40% by weight of a further unsaturated monomer other than a.A) and a.B), but copolymerizable with these, where (a.A) to (a.C) together give 100% by weight, and from 0 to 80 parts by weight of further polymers, and also amounts of from 0 to 150 parts by weight of conventional additives, are added to 100 parts by weight of this polymerized mixture;
and b. comprises:
   A) from 20 to 99% by weight of a methyl (meth)-acrylate of the formula I,
   where
      R₁ is hydrogen or methyl and
      R₂ is a linear or branched alkyl radical or cycloalkyl radical having from 1 to 18 carbon atoms, or is phenyl or naphthyl,
   B) from 1 to 80% by weight of one or more ethylenically unsaturated “reactive monomers” other than b.A) but copolymerizable with (b.A), where (b.A) and (b.B) together give 100% by weight and from 0% by weight to 80 parts by weight of further polymers, and also amounts of from 0% by weight to 150 parts by weight of conventional additives, are added to 100 parts by weight of this polymerized mixture,
and, if appropriate, comprises c.,
   where c. can be a further polymer.

The ratio by weight between a. and b. may be from 50:50 to 100:0, and if a polymer of group c. is present the proportion of a. reduces correspondingly.

If the temperatures at which the polymethyl (meth)-acrylate layer is applied to the material for coating are such as permit the polymethyl (meth)acrylate layer to enter into chemical bonding with the material, the result is an advantageous and, surprisingly, extremely elegant method of achieving the object. The inventive process permits the surface-finishing of a wide variety of materials without use of multilayer systems or use of adhesives, in that the polymethacrylic layer is composed of a blend of two polymers based on poly-(meth)acrylate, where one of the constituents of the surface finish provides the properties of pure poly-methyl (meth)acrylate and the other portion provides the appropriate means for linkage of this layer to the substrate. The active chemical crosslinking of the polymer layer to the substrate here is formed via the elevated temperature during the finishing process. Alongside the formation of chemical bonds here, some degree of interpenetration between substrate and polymer layer can act to promote adhesion (in particular in the case of porous, rough or fibrous substrate materials).

Component a.A) is an essential component. This is methyl (meth)acrylate, which makes up from 20 to 100% by weight of the polymerizable mixture a. from which the polymer layer is obtainable. If its proportion makes up 100% by weight, this mixture corresponds to homo-PMMA. If the proportion is smaller than 100% by weight, the polymer is a co- or terpolymer composed of 3 or more types of monomer. The polymerized mixture a. is then a co- or terpolymer.

Component a.B) is therefore optional. It involves an acrylic or methacrylic ester other than methyl methacrylate. A linear or branched C₁-C₁₈-alkyl radical is a range of alkyl radicals extending from methyl via ethyl to a radical encompassing 18 carbon atoms. Also encompassed here are all of the conceivable structural isomers within the group. Mention may particularly be made of butyl methacrylate, 2-ethylhexyl methacrylate, cyclohexyl methacrylate, phenyl methacrylate, and also naphthyl methacrylate.

In the mixtures a.B) it is preferable to use (meth)-acrylates where the radical R₂ of the (meth)acrylate of the formula I encompasses a linear or branched C₁-C₈-alkyl radical. Among these, the methyl, ethyl or n-butyl radical is in turn particularly suitable for R₂ .

The expression “(meth)acrylate” means acrylate and/or methacrylate for the purposes of the invention.

The polymerizable component a.C) for obtaining the polymethyl (meth)acrylate layer is optional. Monomers other than a.A) and a.B) are understood by the person skilled in the art to be styrene and its derivatives, vinyl esters, e.g. vinyl acetate, vinyl propionate, vinyl esters of higher-alkyl acids, vinyl chloride, vinyl fluoride, olefins, e.g. ethene, propene, isobutene, and the like.

The polymerized mixtures a. and b. usually also comprise amounts of up to 150 parts by weight of additives known per se (per 100 parts by weight of a.A)-a.C) and, respectively, b.A) and b.B)). By way of example, mention may be made of calcium carbonate (chalk), titanium dioxide, calcium oxide, perlite, and precipitated and coated chalks as rheologically active additives, and also, where appropriate, agents with thixotropic action, e.g. fumed silica. The grain size is mostly in the range from 5 to 25 μm. As required by the use of the material, the mixture a. or b. may also comprise auxiliaries known per se, e.g. adhesion promoters, wetting agents, stabilizers, flow control agents, or blowing agents in proportions of from 0 to 5% by weight (based on the mixtures a.A) to a.C) and, respectively, b.A) and b.B)). By way of example, mention may be made of calcium stearate as flow control agent.

In the interest of completeness, mention should be made of the possibility of also admixing further components or polymers c., such as impact modifiers and impact-modified PMMA moulding compositions, with the polymerized mixtures a. and/or b. (DE 38 42 796 and DE 19 813 001). The polymeric mixtures a. and/or b. preferably also comprise further polymers used in industrial processes, and these may be selected, inter alia, from the group of the polyvinylidene difluorides (PVDF), PVC, polyethylenes, polypropylene, polyesters, polyamides. Very particular preference is given in this connection to the use of vinylidene-fluoride-based fluoropolymers (WO 00/37237). If a polymer of group c. is present, the proportion of a. reduces correspondingly, and in particular embodiments a. may also be completely replaced by c.

Component b.A) encompasses the entirety of components a.A) and a.B).

Component b.B) in the mixture b. is a “reactive monomer” which has adhesion-improving properties. The adhesion-improving monomers (reactive monomers) which are constituents of the polymethyl (meth)acrylates are those monomers capable of free-radical polymerization which have functional groups which can interact with the materials to be coated. This interaction is to be brought about at least via a chemical (covalent) bond. In addition, it may be promoted, by way of example, by hydrogen bonding, complexing, dipole forces or thermodynamic compatibility (intertwining of the polymer chains) or the like. The interactions generally involve heteroatoms, such as nitrogen or oxygen. Functional groups which may be mentioned are the amino group, in particular the dialkylamino group, (cyclic) amide group, imide group, hydroxy group, (ep)oxy group, carboxy group, (iso)cyano group.

These monomers are known per se (cf. H. Rauch Puntigam, Th. Völker, Acryl- und Methacrylverbindungen [Acrylic and methacrylic compounds], Springer-Verlag 1967; Kirk-Othmer, Encyclopedia of Chemical Technology, 3rd. Ed., Vol. 1, pp. 394-400, J. Wiley 1978; DE-A 25 56 080; DE-A 26 34 003).

The adhesion-improving monomers therefore preferably belong to the monomer class of the nitrogen-containing vinyl heterocycles preferably having 5-membered rings alongside 6-membered rings, and/or of the copolymerizable vinylic carboxylic acids and/or of the hydroxyalkyl-, alkoxyalkyl-, epoxy- or aminoalkyl- substituted esters or amides of fumaric, maleic, itaconic, acrylic, or methacrylic acid.

Nitrogen-heterocyclic monomers which may particularly be mentioned are those from the class of the vinyl-imidazoles, of the vinyllactams, of the vinylcarbazoles, and of the vinylpyridines. Examples of these monomeric imidazole compounds, which are not intended to represent any form of restriction, are N-vinylimidazole (also termed vinyl-1-imidazole), N-vinylmethyl-2-imidazole, N-vinylethyl-2-imidazole, N-vinylphenyl-2-imidazole, N-vinyldimethyl-2,4-imidazole, N-vinylbenzimidazole, N-vinylimidazoline (also termed vinyl-1-imidazoline), N-vinylmethyl-2-imidazoline, N-vinylphenyl-2-imidazoline and vinyl-2-imidazole.

Particular examples which may be mentioned of monomers derived from the lactams are compounds such as the following: N-vinylpyrrolidone, N-vinylmethyl-5-pyrrolidone, N-vinylmethyl-3-pyrrolidone, N-vinylethyl-5-pyrrolidone, N-vinyldimethyl-5,5-pyrrolidone, N-vinyl-phenyl-5-pyrrolidone, N-allylpyrrolidone, N-vinyl-thiopyrrolidone, N-vinylpiperidone, N-vinyldiethyl-6,6-piperidone, N-vinylcaprolactam, N-vinylmethyl-7-caprolactam, N-vinylethyl-7-caprolactam, N-vinyl-dimethyl-7,7-caprolactam, N-allylcaprolactam, N-vinyl-caprylolactam.

Among the monomers which derive from carbazole mention may particularly be made of: N-vinylcarbazole, N-allylcarbazole, N-butenylcarbazole, N-hexenyl-carbazole and N-(methyl-1-ethylene)carbazole. Among the copolymerizable vinylic carboxylic acids, mention may in particular be made of maleic acid, fumaric acid, itaconic acid and suitable salts, esters or amides of the same.

Mention may also be made of the following epoxy-, oxy- or alkoxy-substituted alkyl esters of (meth)acrylic acid: glycidyl methacrylate, 2-hydroxyethyl (meth)-acrylate, hydroxypropyl (meth)acrylate, 2-methoxyethyl (meth)acrylate, 2-ethoxyethyl (meth)acrylate, 2-butoxy-ethyl (meth)acrylate, 2-(2-butoxyethoxy)ethyl meth-acrylate, 2-(ethoxyethyloxy)ethyl (meth)acrylate, 4-hydroxybutyl (meth)acrylate, 2-[2-(2-ethoxyethoxy)-ethoxy]ethyl (meth)acrylate, 3-methoxybutyl 1-(meth)-acrylate, 2-alkoxymethylethyl (meth)acrylate, 2-hexoxy-ethyl (meth)acrylate.

Mention may also be made of the following amine-substituted alkyl esters of (meth)acrylic acid: 2-dimethylaminoethyl (meth)acrylate, 2-diethylamino-ethyl (meth)acrylate, 3-dimethylamino-2,2-dimethylpropyl 1-(meth)acrylate, 3-dimethylamino-2,2-dimethylpropyl 1-(meth)acrylate, 2-morpholinoethyl (meth)acrylate, 2-tert-butylaminoethyl (meth)acrylate, 3-(dimethyl-amino)propyl (meth)acrylate, 2-(dimethylaminoethoxy-ethyl) (meth)acrylate.

Mention may be made by way of example of the following monomers which are representatives of the (meth)acryl-amides: N-methyl(meth)acrylamide, N-dimethylaminoethyl-(meth)acrylamide, N-dimethylaminopropyl(meth)acrylamide, N-isopropyl(meth)acrylamide, N-tert-butyl(meth)acryl-amide, N-isobutyl(meth)acrylamide, N-decyl(meth)acryl-amide, N-cyclohexyl(meth)acrylamide, N-[3-(dimethyl-amino)-2,2-dimethylpropyl]methacrylamide, N-[2-hydroxy-ethyl](meth)acrylamide.

In the mixture b., it is advantageous to use “reactive monomers” selected from the group consisting of GMA (glycidyl methacrylate) , maleic acid derivatives, such as maleic acid, maleic anhydride (MA), methylmaleic anhydride, maleimide, methylmaleimide, maleamides (MAs), phenylmaleimide and cyclohexylmaleimide, fumaric acid derivatives, methacrylic anhydride, acrylic anhydride.

The ratio of the polymerized monomer mixtures a. and b. in the polymethyl (meth)acrylate-based surface finish may be selected by the person skilled in the art as desired and adapted to the substrate to be protected. For cost reasons, component a. will generally be predominant in the polymerized layer. It is preferable to use 50 to 100% by weight of the polymerized mixture a., to the corresponding amount of b. The a.:b. ratio should particularly preferably be 60-90:40-10% by weight. It is very particularly preferable to utilize a mixture of the polymers where a.:b. is 75-85:25-15% by weight.

The composition of further preferred polymer layers is set out below:
a.A: from 20 to 100% by weight, preferably from 30 to 100% by weight, particularly preferably from 40 to 99% by weight
a.B: from 0 to 80% by weight, preferably from 0 to 70% by weight, particularly preferably from 1 to 60% by weight
a.C: from 0 to 40% by weight, preferably from 0 to 35% by weight, particularly preferably from 0 to 32% by weight
   additives to a.: from 0 to 150 parts by weight, preferably from 0 to 100 parts by weight, particularly preferably from 0 to 50 parts by weight.
b.A: from 20 to 99% by weight, preferably from 30 to 99% by weight, particularly preferably from 40 to 98% by weight
b.B: from 1 to 80% by weight, preferably from 1 to 70% by weight, particularly preferably from 2 to 60% by weight
   additives to b.: from 1 to 150 parts by weight, preferably from 0 to 100 parts by weight, particularly preferably from 0 to 50 parts by weight.

Further additives which may be used also comprise UV absorbers. Improved weathering resistance of the inventive coating is achieved via incorporated UV stabilizers which are known additives for plastics and are listed in Ullmanns Enzyklopädie der technischen Chemie [Ullmann's Encyclopaedia of Industrial Chemistry], 4th Edition, Volume 15, pages 253-260, and/or via polymerizable UV stabilizers. 3-(2-Benzotriazolyl)-2-hydroxy-5-tert-octylbenzylmethacrylamide may be mentioned as an example of polymerizable UV stabilizers. Use is advantageously made of triazine-based UV absorbers (e.g. CGX UVA 006 from Ciba), which have high intrinsic UV resistance and therefore give the film membrane the required long-term stability. Examples of amounts which may be present of UV absorbers are from 0.1 to 10% by weight, based on the polymer.

The high UV resistance is retained even on prolonged exposure to radiation if the plastic comprises a very small amount of a sterically hindered amine. Appropriate compounds scavenge free radicals which form under radiative stress and which otherwise would cause slow breakdown of the plastics material. These additives are described in the Japanese patent JP 03 47,856 and are termed “hindered amine light stabilizers”, abbreviated to “HALS”.

Examples of UV absorbers which may be used are the products CGX UVA 006 or Tinuvin 328 (Ciba), and HALS products used comprise Chimassorb 119 FL or Tinuvin 770 (producer: Ciba SC).

Other additives which may be used are flame retardants. Flame retardants and/or flame-retardant additives are known to the person skilled in the art. They are inorganic and/or organic substances which in particular are intended to provide flame retardancy to wood and wood materials, plastics or textiles (render these flame retardant). They achieve this by inhibiting ignition of the substances to be protected and making combustion more difficult.

Flame retardants and/or flame-retardant additives encompass, inter alia, substances which suppress fire, promote carbonization, form a barrier layer, and/or form an insulating layer. Examples of these are specific inorganic compounds, such as aluminium oxide hydrates, aluminium hydroxides, water glass, borates, in particular zinc borates, antimony oxide (mostly together with organic halogen compounds), ammonium phosphates, such as (NH₄)₂HPO₄, and ammonium polyphosphates.

Other flame retardants and/or flame-retardant additives which may be used encompass halogenated organic compounds, such as chloroparaffins, hexabromobenzene, brominated diphenyl ethers and other bromine compounds, organophosphorus compounds, especially phosphates, phosphites and phosphonates, in particular those with plasticizer action, e.g. tricresyl phosphate, halogenated organophosphorus compounds, such as tris-(2,3-dibromopropyl)phosphate or tris(2-bromo-4-methyl-phenyl)phosphate. Other examples of flame retardants and/or flame-retardant additives which may be used are substances which expand on heating to form a foam, carbonize at from 250 to 300° C., and during this process solidify and form a fine-pored, highly insulating pad; e.g. mixtures of urea, dicyandiamide, melamine and organic phosphates.

These flame retardants and/or flame-retardant additives are preferably those which in the event of a fire do not form any environmentally hazardous substances, such as toxic phosphates and highly toxic dioxins.

The polymer mixtures mentioned may be polymerized individually by methods known to the person skilled in the art, and mixed and finally used for surface finishing. The method of applying the resultant polymer layer to the substrate may in turn be one known to the person skilled in the art. However, the temperature established is adequate to give adequate formation of the covalent surface bonds or other attachment mechanisms and to give interpenetration of the strands of polymer at the surface into the substrate. This temperature is generally above the glass transition temperature of the polymer layer to be applied. It is particularly advantageous for this temperature to be set significantly above the glass transition temperature (T_{G}), therefore being >T_{G}+20° C., particularly preferably >T_{G}+50° C. and very particularly preferably >T_{G}+80° C.

Preferred processes for applying the surface finish are common technical knowledge (Henson, Plastics Extrusion Technology, Hanser Publishers, 2nd Edition, 1997). Among preferred processes for applying the polymethyl (meth)acrylate layer in the form of a melt are coextrusion coating and melt coating. The surface finish in the form of a film may be applied by lamination, extrusion lamination, adhesive bonding, coil coating, sheathing or high-pressure lamination. Other descriptions of the production process are found by the skilled worker in “Kunststoffverarbeitung” [Plastics processing] by Schwarz, Ebeling and Furth, Vogel-Verlag, p. 33, 9th Edition, (2002) under keyword “Extrusionsbeschichtung” [Extrusion coating], and also in “Reifenhäuser News”, Issue 30 (06/2004).

Another process variant for producing the inventive plastic consists in applying, to one of the sides of the plastics moulding (layer 2), a first layer of a further plastic (layer 1), and in a second step, preferably to be carried out simultaneously with the first step, applying a melt film composed of layers 4 and 5 as coextrudate to the other side of the plastics moulding.

Another embodiment of the invention concerns the composite materials produced according to the invention. In principle, according to the invention the polymer layers may be applied to any of the materials which the person skilled in the art may use for this purpose. Materials to be selected with preference comprise: wood, wood veneer, paper, other polymer materials, such as polyolefins, polystyrenes, polyvinyls, polyesters, polyamides, synthetic or natural rubbers, metals, thermoset materials, such as high-pressure laminates.

The substrate materials may take the form of film, trimmed film, sheet or trimmed sheet. In this context, particular emphasis should be given to substrate materials such as polyethylene textiles or polypropylene textiles, e.g. those used in the greenhouse film industry. Examples of materials particularly preferred for the invention are greenhouse film membranes composed of interwoven HDPE filaments. The individual filaments have been oriented in such a way as to give high strength values in the direction in which the filaments are subjected to load. Both sides of the interwoven-filament material may have an LDPE coating.

The greenhouse film membranes are marketed by PT Carillon with the name SOLARSHIELD®.

The inventive film composites and the comparative specimens were tested using the following methods:
Tensile test: 23° C./50% rel. humidity, ISO 527-3/2/100
Tear-propagation test: 23° C./50% rel. humidity, ASTM D1938, 23° C., test velocity 100 mm/min
Transmittance spectrum τ(λ) with wavelength 250 nm≦λ≦2500 nm: total transmittance measured by means of a twin-beam spectrophotometer with integration sphere as described in ISO 13468-2. The side of the film that faces toward the light source during the test is the side of the film that faces toward the sun.
Light transmittance τ_{D65}: from τ(λ) where 380 nm≦λ≦780 nm, to ISO 13468-2.
Solar transmittance: solar transmittance to ASTM E903-96, calculated for direct normal solar spectral irradiance at air mass 1.5 from the transmittance spectrum τ(λ) with wavelength 300 nm≦λ≦2500 nm.
Transmittance spectrum from wavelength 2.5 μm to 25 μm: to measure the transmittance spectrum in the middle infrared (from 2.5 to 25 μm), the Nicolet Magna 550 FT-IR spectrometer was used with a DTGS detector at resolution of 4 wave numbers. A background spectrum was first recorded for the empty chamber, and then the film was placed in the beam path. 4 interferograms were recorded in transmittance mode. After Fourier transformation and, if appropriate, baseline subtraction, the transmittance is obtained as a function of wave number. The wavelength is the reciprocal of the wave number.
Accelerated weathering in Atlas “Xenotest Alpha” equipment, using the following parameters: irradiation intensity 180±9 W/m² at wavelength from 300 to 400 nm, wavelength threshold 300 nm, test cycle: 102 min of radiation, 18 min of radiation with water spray, without sample inversion, black standard temperature 65±3° C., sample space temperature: 36±4° C., relative humidity: 65±10%. The weathering time is 5419 h. Under the conditions mentioned, this corresponds approximately to about 15-20 years of outdoor weathering in Darmstadt.

All the specimens were taken in such a way that the two perpendicular principal directions of the strands of the PE textile were parallel to the external dimensions of the test specimens. For the tensile test, tear-propagation test and creep test the direction of loading was parallel to the direction of extrusion.

### EXAMPLE 1

Greenhouse film from PT Carillon (HDPE textile as layer 2+both sides coated with LDPE, layers 1 and 3), (layer 1: 65 μm, layer 2: 96 g/m²≈120 μm, layer 3: 55 μm)

Total thickness 0.24 mm

### Properties:

| | |
|---|---|
| Tensile test - tensile strength [MPa] | 79.5 |
| Tensile test - tensile strain at break | 35 |
| [%] | |
| Tear-propagation test - average tear- | 52.5 |
| propagation force [N] | |
| Light transmittance τ_{D65} [%] | 82.0 |
| Transmittance spectrum, 250-2500 nm | FIG. 1.a |
| Transmittance spectrum, 2.5-25 μm | FIG. 1.b |
| Light transmittance τ_{D65} after 5419 h of | 75.1 |
| accelerated weathering [%] | |

### Result:

The PE textile has high light transmittance and also good permeability to insolation. However, light transmittance falls by about 7% during accelerated weathering under the conditions mentioned.

However, the PE textile is permeable to a major portion of the heat emitted by the ground. Specifically, if the ground is regarded as a black-body source with a temperature of 60° C., the resultant emission spectrum is that shown by the broken line in FIG. 1.b. This shows that the emission maximum occurs at a wavelength of about 9 μm, and that the wavelength range where energy density is at least 50% of the maximal extends from about 6 to about 16 μm. A local maximum of transmittance of the textile (about 40%) at a wavelength of 9 μm is coincident with the maximum of the ground-emission spectrum.

Permeability to insolation is therefore good (≈80%) but the PE textile is then permeable to a considerable portion of the heat emitted by the insolation-heated ground (≈40% at the maximum-emission wavelength), this emitted heat therefore being lost.

### EXAMPLE 2

Textile from Example 1/adhesion promoter: Bynel 22 E 780 from DuPont/mod. PMMA. The PMMA is a mixture of 58 parts by weight of Plex 8745 F and 40 parts by weight of reactive modifier and 2 parts by weight of Tinuvin 360. (producer: Ciba). The product Plex 8745 F is obtainable from Röhm GmbH & Co. KG. The reactive modifier is a copolymer of methyl methacrylate, methyl acrylate and methacrylic acid in a ratio of 88:4:8 by weight.

Coextrusion coating

Total thickness 0.32 mm

The use of coextrusion coating technology (PMMA and adhesion promoter being brought into contact before they leave the extrusion die and are applied together in the form of melt film to the substrate to be coated) gives markedly increased adhesion between textile and PMMA, when comparison is made with lamination/extrusion lamination technology (Example 3).

### Properties

| | |
|---|---|
| Tensile test - tensile strength [MPa] | 63.2 |
| Tensile test - tensile strain at break | 28 |
| [%] | |
| Tear-propagation test - average tear- | 31.9 |
| propagation force [N] | |
| Light transmittance τ_{D65} [%] | 81.91 |
| Transmittance spectrum, 250-2500 nm | FIG. 2.a |
| Transmittance spectrum, 2.5-25 μm | FIG. 2.b |
| Solar transmittance [%] | 79.25 |
| Light transmittance τ_{D65} after 5419 h of | 80.8 |
| accelerated weathering | |

### Result:

When compared with the textile from Example 1, this film composite exhibits high light transmittance and also good permeability to insolation. Solar transmittance and light transmittance are about 80%. Light transmittance falls by only a little more than 1% during accelerated weathering under the conditions mentioned, i.e. by markedly less than in Comparative Example 1 using the unmodified PE textile. Application of the PMMA layer therefore leads to a marked rise in the life time of the material.

Surprisingly, and in contrast to PE textile of Example 1, this film composite exhibits only very low transmittance for the radiant heat emitted from the ground. The PMMA layer is necessary for this effect. Specifically, if the ground is regarded as a black-body source with a temperature of 60° C., the resultant emission spectrum is that shown by the broken line in FIG. 2.b. This shows that the emission maximum occurs at a wavelength of about 9 μm, and that the wavelength range where energy density is at least 50% of the maximal extends from about 6 to about 16 μm. In this high-heat emission wavelength range, the spectral transmittance of the film composite is not more than 20%, and on average it is below 10%.

Permeability to insolation is therefore good (≈80%), but the film composite is impermeable (≈10%) to the heat emitted by the insolation-heated ground. This is an advantage over the unmodified PE textile, which at wavelength 9 μm allows about 40% of the radiant heat to escape again, as shown in Example 1. Like the PE textile of Example 1, the film composite of Example 2 exhibits good mechanical properties in terms of toughness with high tensile strength and high tear-propagation force.

### EXAMPLE 3

Textile from Example 1/MORMELT 902 adhesion promoter from Röhm & Haas/mod. PMMA—lamination. The PMMA is a mixture of 58 parts by weight of Plex 8745 F and 40 parts by weight of reactive modifier and 2 parts by weight of Tinuvin 360. (producer: Ciba) The product Plex 8745 F is obtainable from Röhm GmbH & Co. KG. The reactive modifier is a copolymer of methyl meth-acrylate, methyl acrylate and methacrylic acid in a ratio of 88:4:8 by weight.

Total thickness 0.42 mm

The use of lamination technology (PMMA being in film form when brought into contact with the adhesion-promoter melt) leads to markedly poorer adhesion of the PMMA layer, when compared with coextrusion coating.

### Properties

| | |
|---|---|
| Tensile test - tensile strength [MPa] | 48.4 |
| Tensile test - tensile strain at break | 25 |
| [%] | |
| Tear-propagation test - average tear- | 60.7 |
| propagation force [N] | |
| Light transmittance τ_{D65} [%] | 80.3 |
| Transmittance spectrum, 250-2500 nm | FIG. 3 |

### Result:

When compared with the PE textile from Example 1, the film composite exhibits the same high light transmittance and likewise exhibits good permeability to insolation. The absorption in the UV region is principally a function of the UV absorbers used and their concentration and can be adjusted within wide limits.

Like the PE textile, the film composite exhibits good mechanical properties in terms of toughness with high tensile strength and tear-propagation force.

### EXAMPLE 4

Greenhouse film from PT Carillon (HDPE textile+one side coated with LDPE)/Bynel 22 E 780 adhesion promoter from DuPont/mod. PMMA-PVDF. The PMMA-PVDF is a mixture of 58.5 parts by weight of PVDF, 40 parts by weight of reactive modifier and 1.5 parts by weight of Tinuvin 360, the PVDF used being the product KT 1000 from Kureha. The reactive modifier is a copolymer of methyl methacrylate, methyl acrylate and methacrylic acid in a ratio of 88:4:8 by weight.

Coextrusion coating

Total thickness 0.31 mm

The PMMA is exclusively reactive PMMA (copolymerized functional groups for linkage to the adhesion promoter). The PVDF fraction leads to better fire performance.

### Properties

| | |
|---|---|
| Tensile test - tensile strength [MPa] | 72.3 |
| Tensile test - tensile strain at break | 30.0 |
| [%] | |
| Tear-propagation test - average tear- | 31.7 |
| propagation force [N] | |
| Light transmittance τ_{D65} [%] | 76.82 |
| Transmittance spectrum, 250-2500 nm | FIG. 4.a |
| Transmittance spectrum, 2.5-25 μm | FIG. 4.b |

### Properties

Properties are good and similar to those in Examples 2 and 3. For example, transmittance for radiant heat from the ground is low and similar to that in Example 3. The PVDF fraction does not lead to any impairment.

1. Plastics moulding of multilayer structure, where the individual layers are composed of the following materials:
layer 1 of an olefinic polymer or of an ethyl-vinyl acetate polymer or of a copolymer of an olefin and ethyl-vinyl acetate,
layer 2 of a textile of oriented fibres of a thermoplastic polymer,
layer 3 of an olefinic polymer or of an ethyl-vinyl acetate polymer or of a copolymer of an olefin and ethyl-vinyl acetate,
layer 4 of an adhesion promoter,
layer 5 of a polymethyl methacrylate.

2. Plastics moulding according to claim 1,
characterized in that
layer 1 has a thickness of from 20 to 100 μm,
layer 2 is composed of a textile of oriented fibres with dimensions from 8 mm×8 mm to 12 mm×12 mm fibres per inch (4.54 cm) 1400 to 800 dernier,
layer 3 has a thickness of from 0 μm to 100 μm,
layer 4 has a thickness of from 2 μm to 100 μm,
layer 5 has a thickness of from 5 μm to 150 μm.

3. Plastics moulding according to claim 1,
characterized in that
layer 2 is composed of a high-density polyethylene (HDPE).

4. Plastics moulding according to claim 1,
characterized in that
layer 1 and layer 3 are composed of
a) a polar copolymer of EVA and LDPE or
b) of EVA or
c) of LDPE or
d) of copolymers of LDPE and polar comonomers or
e) of copolymers of PE and polar comonomers.

5. Plastics moulding according to claim 1,
characterized in that
layer 4 is composed of copolymers of PE and other, polar monomers.

6. Plastics moulding according to claim 1,
characterized in that
layer 4 is composed of a solvent-based adhesive.

7. Plastics moulding according to claim 1,
characterized in that
layer 4 is composed of a modified PE.

8. Plastics moulding according to claim 1,
characterized in that
layer 5 is composed of a PMMA copolymer of the following constitution: of polymerized monomer mixtures a, b and, if appropriate, c, where a. comprises:
A) from 20 to 100% by weight of methyl meth-acrylate,
B) from 0 to 80% by weight of a (meth)acrylate of the formula I, other than methyl meth-acrylate, 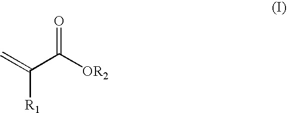
where
R₁ is hydrogen or methyl and
R₂ is a linear or branched alkyl radical or cycloalkyl radical having from 1 to 18 carbon atoms or is phenyl or naphthyl,
C) from 0 to 40% by weight of a further unsaturated monomer other than a.A) and a.B), but copolymerizable with these, where (a.A) to (a.C) together give 100% by weight, and from 0 to 80 parts by weight of further polymers, and also amounts of from 0 to 150 parts by weight of conventional additives, are added to 100 parts by weight of this polymerized mixture;
and b. comprises:
A) from 20 to 99% by weight of a methyl (meth)-acrylate of the formula I,
where
R₁ is hydrogen or methyl and
R₂ is a linear or branched alkyl radical or cycloalkyl radical having from 1 to 18 carbon atoms, or is phenyl or naphthyl,
B) from 1 to 80% by weight of one or more ethylenically unsaturated “reactive monomers” other than b.A) but copolymerizable with (b.A), where (b.A) and (b.B) together give 100% by weight, and where from 0 to 80 parts by weight of further polymers, and also amounts of from 0 to 150 parts by weight of conventional additives, are added to 100 parts by weight of this polymerized mixture
and the ratio by weight between a. and b. can be from 50:50 to 100:0,
and the optionally present component c. can be a polymer.

9. Plastics moulding according to claim 8,
characterized in that
the PMMA polymer has been rendered impact-resistant.

10. Plastics moulding according to claim 8,
characterized in that
the component c. used comprises a polymer from the group consisting of polyvinylidene fluoride, polyvinyl chloride, polyethylene, polypropylene, polyester or polyamides, and the polymer a is replaced either completely or to some extent by the polymer c.

11. Process for the extrusion coating of plastics mouldings,
characterized in that
a first layer composed of a further plastic is applied to the lower side of the plastics moulding, and optionally, in a second step preferably to be carried out simultaneously with the first step, a second plastics layer is applied to the upper side of the plastics moulding, and then a third plastics layer is applied to the upper side of the second plastics layer, and then the PMMA layer is applied as final layer.

12. Process for the extrusion coating of plastics mouldings according to claim 11,
characterized in that
one or more flame retardants is/are added to one or more of the layers 1 to 5.

13. Process for the extrusion coating of plastics mouldings according to claim 11 or 12,
characterized in that
the layers 4 and 5 are applied in the form of a multilayer melt film.

14. Process for the extrusion coating of plastics mouldings according to any of claims 11 to 13,
characterized in that,
preferably in one simultaneous operation, layer 1 is extruded onto the lower side of layer 2 and layers 3 to 5 are extruded in the form of a multi-layer melt film (coextrudate) onto the upper side of layer 2.

15. Plastics moulding according to claim 8,
characterized in that
use is made of light stabilizers, such as UV absorbers and HALS (hindered amine light stabilizers).

16. Plastics moulding according to claim 15,
characterized in that
the UV absorbers used comprise triazines.

17. Use of the plastics moulding according to claim 1 in outdoor applications, such as greenhouse films and architectural membranes.
